(19) United States
(12) Patent Application Publication
(10) Pub. No.: US 2025/0392524 A1
(43) Pub. Date: Dec. 25, 2025

(54) CONFIGURING COMMUNICATIONS NETWORK PARAMETERS

(71) Applicant: Meta Platforms, Inc., Menlo Park, CA (US)

(72) Inventor: Murali Ranganathan, San Diego, CA (US)

(73) Assignee: Meta Platforms, Inc., Menlo Park, CA (US)

(21) Appl. No.: 19/244,596

(22) Filed: Jun. 20, 2025

Related U.S. Application Data
(60) Provisional application No. 63/663,024, filed on Jun. 21, 2024.

(51) Int. Cl. H04L 41/16; H04L 43/0817

(52) U.S. Cl. CPC H04L 41/16; H04L 43/0817

(57) ABSTRACT

As disclosed herein, a computer-implemented method for configuring communications network parameters using quality of experience metrics is provided. The computer-implemented method may include determining, by a computing platform, a quality of experience metric of an application associated with the computing platform. The computer-implemented method may include providing the quality of experience metric to an artificial intelligence model executing on the computing platform. The computer-implemented method may include determining, by the artificial intelligence model and based on the quality of experience metric, a recommended configuration for a communications network associated with the computing platform. The computer-implemented method may include providing the recommended configuration to an operator of the communications network. A system and a non-transitory computer-readable storage medium are also disclosed.

### CROSS-REFERENCE TO RELATED APPLICATION

This application claims the benefit of U.S. Application Ser. No. 63/663,024, filed Jun. 21, 2024, the entirety of which is hereby incorporated by reference.

### BACKGROUND

### Field

The present disclosure generally relates to communications network configuration. More particularly, the present disclosure relates to configuring communications network parameters using quality of experience metrics.

### Related Art

Communications networks are essential for supporting computing platforms that provide a wide array of products and services. Traditionally, management and optimization of a communications network rely heavily on key performance indicators (KPIs), such as latency, throughput, packet loss, accessibility, retainability, and availability, which provide valuable insights into network performance. A network operator may monitor KPIs to ensure the communications network meets performance goals and satisfies service level agreements.

### SUMMARY

The subject disclosure provides for systems and methods for configuring communications network parameters using quality of experience metrics. An artificial intelligence model executing on a computing platform may be trained using quality of experience data and network configuration data. The quality of experience data may be associated with the computing platform, and the network configuration data may be associated with a communications network supporting the computing platform. The trained artificial intelligence model may receive as input a quality of experience metric and provide as output a recommended configuration for a communications network.

According to certain aspects of the present disclosure, a computer-implemented method is provided. The computer-implemented method may include determining, by a computing platform, a quality of experience metric of an application associated with the computing platform. The computer-implemented method may include providing the quality of experience metric to an artificial intelligence model executing on the computing platform. The computer-implemented method may include determining, by the artificial intelligence model and based on the quality of experience metric, a recommended configuration for a communications network associated with the computing platform. The computer-implemented method may include providing the recommended configuration to an operator of the communications network.

According to another aspect of the present disclosure, a system is provided. The system may include one or more processors. The system may include a memory storing instructions that, when executed by the one or more processors, cause the system to perform operations. The operations may include determining, by a computing platform, a quality of experience metric of an application associated with the computing platform. The operations may include providing the quality of experience metric to an artificial intelligence model executing on the computing platform. The operations may include determining, by the artificial intelligence model and based on the quality of experience metric, a recommended configuration for a communications network associated with the computing platform. The operations may include providing the recommended configuration to an operator of the communications network.

According to yet other aspects of the present disclosure, a non-transitory computer-readable storage medium storing instructions encoded thereon that, when executed by a processor, cause the processor to perform operations is provided. The operations may include determining, by a computing platform, a quality of experience metric of an application associated with the computing platform. The operations may include providing the quality of experience metric to an artificial intelligence model executing on the computing platform. The operations may include determining, by the artificial intelligence model and based on the quality of experience metric, a recommended configuration for a communications network associated with the computing platform. The operations may include providing the recommended configuration to an operator of the communications network.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an environment in which computerized systems and methods for configuring communications network parameters using quality of experience metrics may operate or be used, according to some embodiments;

FIG. 2 is a block diagram illustrating details of at least one client device and at least one server that may be used in computerized systems, processes, and methods as disclosed herein, according to some embodiments;

FIG. 3 is a block diagram illustrating a system for configuring communications network parameters using quality of experience metrics, according to some embodiments;

FIG. 4 is a flowchart illustrating operations in a method for configuring communications network parameters using quality of experience metrics, according to some embodiments; and

FIG. 5 is a block diagram illustrating an exemplary computer system with which client devices, and the method in FIG. 4, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

Communications networks are essential for supporting computing platforms that provide a wide array of products and services. Traditionally, management and optimization of a communications network rely heavily on key performance indicators (KPIs), such as latency, throughput, packet loss, accessibility, retainability, and availability, which afford valuable insights into network performance. A network operator may monitor KPIs to ensure the communications network meets performance goals and satisfies service level agreements. Although KPIs have served as valuable indicators for network operators to gauge the health and efficiency of communications networks, KPIs come with inherent limitations. One such limitation associated with KPI-based network optimization is the objective nature of KPIs.

KPIs typically include objective metrics, whereas quality of experience (QoE) may include subjective metrics (e.g., user perception of video quality). As a result, it may be difficult to generate a consistent mapping of QoE metrics associated with a computing platform to KPIs associated with a communications network supporting the computing platform. By way of non-limiting example, a user of a computing platform (e.g., a social media platform) may report to the computing platform a poor QoE (e.g., for a video conferencing application), which the computing platform may flag with a network operator of a communications network supporting the computing platform. In turn, the network operator may examine the network KPIs for the network area (e.g., the geographic region) associated with the poor QoE during the time the poor QoE was reported, may determine a root cause for the poor QoE, and may adjust (or tune) one or more network configuration parameters (e.g., bandwidth allocation, routing policies, traffic shaping rules, transmission power levels, or the like) to address the poor QoE. However, the root cause may fail to identify a direct correlation between the QoE and the KPIs because of the subjective nature of QoE and the objective nature of KPIs. For example, in some instances, low throughput may negatively impact QoE, while in other instances, low throughput may not negatively impact QoE. This poor correlation between QoE and KPIs may lead to an inefficient trial-and-error approach to optimizing a network configuration to improve a current QoE or to achieve a target QoE.

There has been growing interest in leveraging artificial intelligence (AI) techniques (e.g., machine learning (ML) techniques) to use QoE metrics to directly inform network configuration decisions, without considering intermediate metrics (i.e., KPIs). An AI-based approach offers several advantages over traditional KPI-based methods. An AI-based approach enables the collection and analysis of a wide range of QoE metrics across diverse computing platform applications and services, allowing a more comprehensive understanding of user experience. Moreover, AI models may learn from evolving network conditions and user behaviors, enabling continuous improvement and optimization over time. Further, an AI-based approach may be more adaptive, dynamically adjusting network parameters based on the preferences or requirements of individual users or applications.

As disclosed herein, novel systems and methods represent a significant advancement in the field of communications network optimization by providing for leveraging AI techniques to map quality of experience data to network configuration data. An AI model executing on a computing platform may be trained using quality of experience data and network configuration data. The quality of experience data may be associated with the computing platform, and the network configuration data may be associated with a communications network supporting the computing platform. The trained artificial intelligence model may receive as input a quality of experience metric and provide as output a recommended configuration for a communications network.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

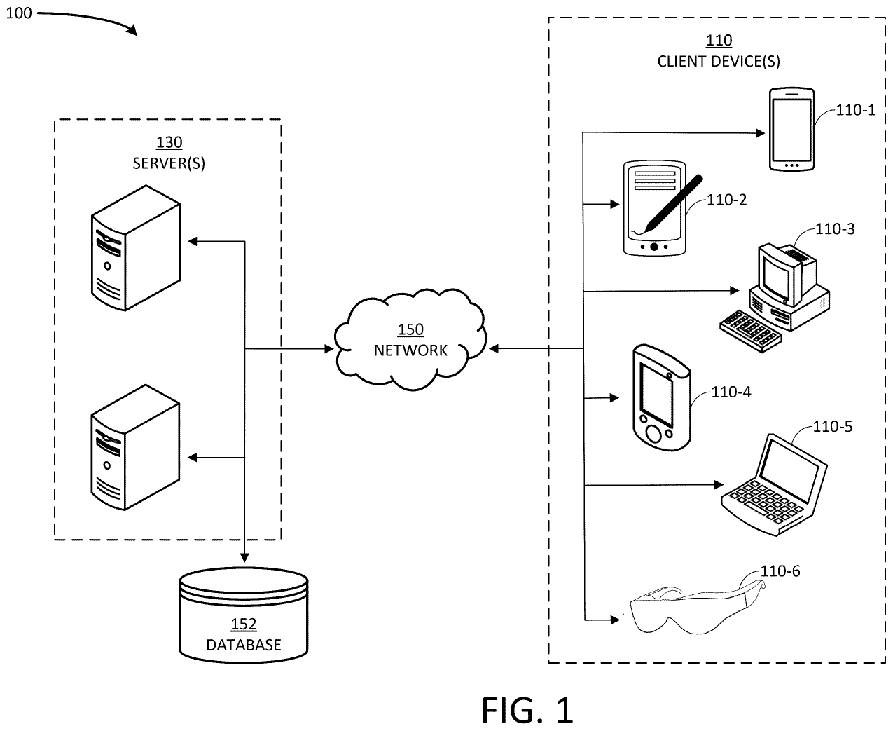

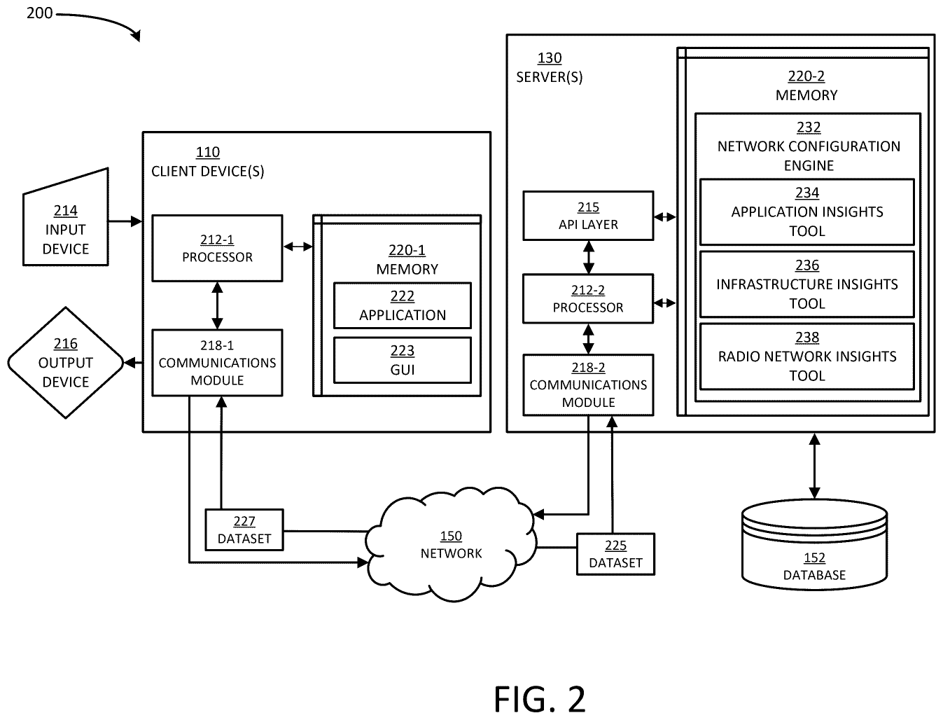

FIG. 1 illustrates an environment 100 in which computerized systems and methods for configuring communications network parameters using quality of experience metrics may operate or be used, according to some embodiments. Environment 100 may include server(s) 130 communicatively coupled with client device(s) 110 and database 152 over network 150. One of server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing a network configuration engine (e.g., network configuration engine 232, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and a database 152 including multiple training archives for the network configuration engine. Moreover, in some embodiments, multiple users of client device(s) 110 may access the same network configuration engine. In some embodiments, a single user with a single client device (e.g., one of client device(s) 110) may provide images and data (e.g., text) to train one or more machine learning models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for hosting the network configuration engine. The network configuration engine may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., a virtual reality headset, augmented reality headset, or smart glass), such that at least one participant may be running an immersive reality application installed therein.

Network 150 may include wireline or wireless networks (e.g., cellular networks, such as 2G-5G and beyond, or Wi-Fi networks). Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating details of client device(s) 110 and server(s) 130 that may be used in computerized systems, processes, and methods as disclosed herein, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an AR/VR headset. For example, in some embodiments, input device 214 may include an eye-tracking device to detect the position of a pupil of a user in an AR/VR headset. Likewise, output device 216 may include a display and a speaker with which the customer may retrieve results from client device(s) 110. Client device(s) 110 may also include a processor 212-1, configured to execute instructions stored in a memory 220-1, and to cause client device(s) 110 to perform at least some of the steps in methods consistent with the present disclosure. Memory 220-1 may further include an application 222 and a graphical user interface (GUI) 223, configured to run in client device(s) 110 and couple with input device 214 and output device 216. Application 222 may be downloaded by the user from server(s) 130 and may be hosted by server(s) 130. In some embodiments, client device(s) 110 may be an AR/VR headset and application 222 may be an immersive reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a participant may upload, with client device(s) 110, dataset 225 onto server(s) 130.

A database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by a processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include network configuration engine 232, which may include application insights tool 234, infrastructure insights tool 236, and radio network insights tool 238. Network configuration engine 232 may share or provide features and resources to GUI 223. A user may access network configuration engine 232 through application 222, installed in memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Network configuration engine 232 may leverage one or more artificial (AI) models (e.g., machine learning (ML) algorithms, such as neural networks, decision trees, or reinforcement learning) to output a recommended or an optimal network configuration to improve or to achieve an input quality of experience (QoE) metric. An AI model may be trained on historical QoE data and historical network configuration data. The AI model may analyze the relationship between QoEs and network configurations to generate a mapping from QoE to network configuration. By simulating the impact of various network configuration parameters on QoE metrics, the AI model may identify network configurations that optimize user experience or meet specific QoE goals.

Application insights tool 234 may collect, analyze, or process one or more QoE metrics of one or more applications associated with one or more computing platforms. Application insights tool 234 may assign a weight to each QoE metric or to the collective QoE metrics associated with each computing platform. The weights may be customizable and may reflect the relative importance of a QoE metric in determining a network configuration for a communication network supporting a computing platform. Application insights tool 234 may generate a weighted sum vector that encapsulates a composite QoE metric based on the QoE metrics and based on the weights assigned to each QoE metric. The weighted sum vector may be used to train, test, or implement an AI model for outputting a recommended or an optimal network configuration to improve or to achieve an input QoE metric.

In some embodiments, an infrastructure insights tool (e.g., infrastructure insights tool 236) may collect, analyze, or process one or more platform infrastructure metrics associated with a computing platform. The infrastructure insights tool may provide the platform infrastructure metrics as inputs to an AI model for outputting a recommended or an optimal network configuration to improve or to achieve an input QoE metric. By way of nonlimiting example, a platform infrastructure metric may include at least one of an availability metric, a bandwidth metric, a bitrate metric, a throughput metric, a jitter metric, a packet loss metric, a latency metric, a processor utilization metric, a memory usage metric, and a storage utilization metric. The infrastructure insights tool may select relevant platform infrastructure metrics based on the impact of a platform infrastructure metric on network performance or QoE.

In some embodiments, a radio network insights tool (e.g., radio network insights tool 238) may collect, analyze, or process one or more radio network metrics associated with a client device hosting an application associated with a computing platform. The radio network insights tool may provide the radio network metrics as input to an AI model for outputting a recommended or an optimal network configuration to improve or to achieve an input QoE metric. By way of nonlimiting example, a radio network metric may include at least one of a signal strength metric, a signal quality metric, a channel utilization metric, an interference level metric, and a mobility patterns metric. The radio network insights tool may select relevant radio network metrics based on the impact of the radio network metric on network performance or QoE.

In some embodiments, network configuration engine 232 may assign a weight (e.g., a user experience weight) to each of a QoE metric (e.g., a discrete or a composite QoE metric), a platform infrastructure metric, and a radio network metric. The weights may be customizable and may reflect the relative importance of each metric in determining a network configuration for a communication network supporting a computing platform. Network configuration engine 232 may generate a weighted sum vector that encapsulates a composite user experience (UX) score based on the QoE metric, the platform infrastructure metric, the radio network metric, and the weights assigned to each metric. The weighted sum vector may be used to train, test, or implement an AI model for outputting a recommended or an optimal network configuration to improve or to achieve an input QoE metric.

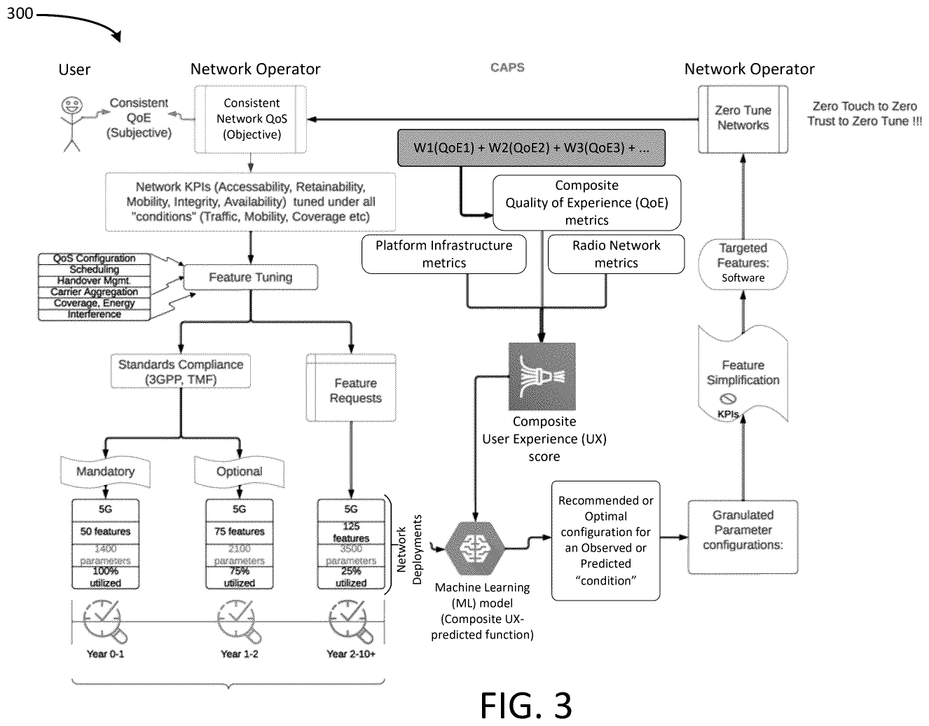

FIG. 3 is a block diagram illustrating a system 300 for configuring communications network parameters using quality of experience metrics, according to some embodiments. As seen in system 300, a user of a computing platform may expect a consistent quality of experience (QoE), which may be qualified or quantified using QoE metrics (e.g., an interaction metric, a perception metric, or an outcome metric). A network provider may track the performance of a network (e.g., a communications network) by measuring KPIs. The KPIs may include an accessibility metric (e.g., a call setup success rate), a retainability metric (e.g., how well a call is maintained without interruption), a mobility metric (e.g., how fast the network can move a user from one cellular tower to another cellular tower), an integrity metric (e.g., how good is throughput during a call), and an availability metric (e.g., how many drops or outages occur while the user is connected to the network).

A network operator may tune a KPI feature under various conditions (e.g., according to geographic region or building type). KPI features may include QoS configuration, scheduling, handover management, carrier aggregation, coverage, energy profile, and interference.

KPI features may be categorized as mandatory, optional, and requested. Mandatory features may be defined by a standard (e.g., by the 5G standard for cellular networks, developed by the 3rd Generation Partnership Project (3GPP), or by a trial master file (TMF) standard), and a network operator must comply with the standard. Optional features may be defined by a standard (e.g., by the 5G standard for cellular networks), and a network operator may comply with the standard. Requested features may be defined by network operators and may include features a network operator chooses to support. Such known network deployments (or such known mappings of KPIs to network configurations), along with QoE data, may be used to train an AI model (e.g., an ML model). Once trained, the model may generate a recommended or an optimal network configuration for an observed condition (e.g., an actual QoE metric) or a predicted condition (e.g., a target QoE metric). A configuration may include granulated network parameter configurations. A computing platform executing the AI model may provide the network parameter configurations to a network operator. The network operator may implement the network parameter configurations.

An application insights tool (e.g., application insights tool 234) of a computing platform executing an AI model for outputting a recommended or an optimal network configuration to improve or to achieve an input QoE metric may collect, analyze, or process one or more QoE metrics of one or more applications associated with one or more computing platforms. The application insights tool may assign a weight (e.g., weights W1, W2, W3, and so on) to each QoE metric or to the collective QoE metrics associated with each computing platform (e.g., discrete or collective QoEs QoE1, QoE2, QoE3, and so on). The weights may be customizable and may reflect the relative importance of a QoE metric in determining a network configuration for a communication network supporting the computing platform. The application insights tool may generate a weighted sum vector, for example,

$$W 1 ( QoE 1 ) + W 2 ( QoE 2 ) + W 3 ( QoE 3 ) + … , \qquad Equation ( 1 )$$

that encapsulates a composite QoE metric based on the QoE metrics and based on the weights assigned to each QoE metric. The weighted sum vector may be used to train, test, or implement the AI model. A recommended or an optimal configuration generated from a composite QoE metric may enable a communications network supporting multiple computing platforms to address QoE concerns for the multiple computing platforms rather than for only the computing platform executing the AI model.

In some embodiments, an infrastructure insights tool (e.g., infrastructure insights tool 236) of a computing platform executing an AI model for outputting a recommended or an optimal network configuration to improve or to achieve an input QoE metric may collect, analyze, or process one or more platform infrastructure metrics associated with the computing platform. The infrastructure insights tool may provide the platform infrastructure metrics as inputs to the AI model. By way of nonlimiting example, a platform infrastructure metric may include at least one of an availability metric, a bandwidth metric, a bitrate metric, a throughput metric, a jitter metric, a packet loss metric, a latency metric, a processor utilization metric, a memory usage metric, and a storage utilization metric. The infrastructure insights tool may select relevant platform infrastructure metrics based on the impact of a platform infrastructure metric on network performance or QoE.

In some embodiments, a radio network insights tool (e.g., radio network insights tool 238) executing an AI model for outputting a recommended or an optimal network configuration to improve or to achieve an input QoE metric may collect, analyze, or process one or more radio network metrics associated with a client device hosting an application associated with a computing platform. The radio network insights tool may provide the radio network metrics as input to the AI model. By way of nonlimiting example, a radio network metric may include at least one of a signal strength metric, a signal quality metric, a channel utilization metric, an interference level metric, a mobility patterns metric, and a capacity metric. The radio network insights tool may select relevant radio network metrics based on the impact of the radio network metric on network performance or QoE.

In some embodiments, a network configuration engine (e.g., network configuration engine 232) executing an AI model for outputting a recommended or an optimal network configuration to improve or to achieve an input QoE metric may assign a weight (e.g., user experience weights UXW1, UXW2, and UXW3) to a discrete or a composite QoE metric (e.g., QoE metric QoE), a platform infrastructure metric (e.g., platform infrastructure metric PI), and a radio network metric (e.g., radio network metric RN). The weights may be customizable and may reflect the relative importance of each metric in determining a network configuration for a communication network supporting a computing platform. The network configuration engine may generate a weighted sum vector, for example,

$$UXW 1 ( QoE ) + UXW 2 ( PI ) + UXW 3 ( RN ) , \qquad Equation ( 2 )$$

that encapsulates a composite user experience (UX) score based on the QoE metric, the platform infrastructure metric, the radio network metric, and the weights assigned to each metric. The weighted sum vector, along with known network deployments (or known mappings of KPIs to network configurations), may be used to train, test, or implement an AI model for outputting a recommended or an optimal network configuration to improve or to achieve an input QoE metric.

The use of QoE metrics to directly inform network configuration decisions may remove intermediate metrics (i.e., KPIs) from consideration when determining a recommended or an optimal network configuration, and may simplify KPI feature tuning for the recommended or the optimal network configuration. Further, the use of QoE metrics to directly inform network configuration decisions may enable a computing platform to provide a network operator with a recommended or an optimal network configuration, which the network operator may incorporate into the software of a communications network, eliminating KPI feature tuning altogether.

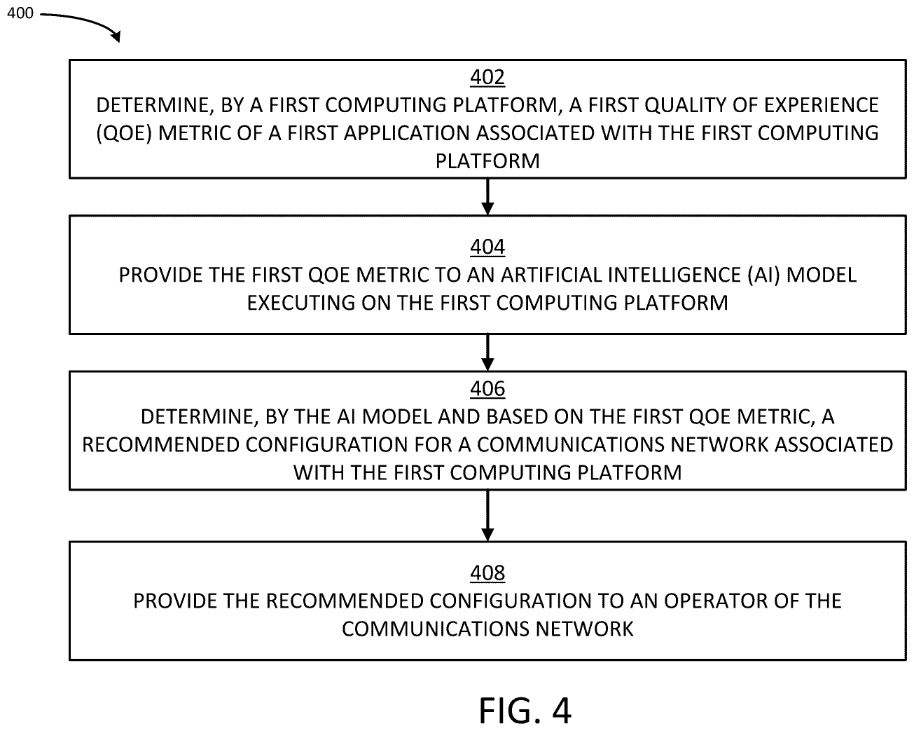

FIG. 4 is a flowchart illustrating operations in a method 400 for configuring communications network parameters using quality of experience metrics, according to some embodiments. In some embodiments, methods as disclosed herein may include one or more steps in method 400 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the steps in method 400 may be performed by a network configuration engine (e.g., network configuration engine 232), which may include at least one of an application insights tool, an infrastructure insights tool, and a radio network insights tool, as disclosed herein (e.g., application insights tool 234, infrastructure insights tool 236, and a radio network insights tool 238). In some embodiments, methods consistent with the present disclosure may include at least one or more steps as in method 400 performed in a different order, simultaneously, quasi-simultaneously, or overlapping in time.

Operation 402 may include determining, by a first computing platform, a first quality of experience (QoE) metric of a first application associated with the first computing platform. In some embodiments, the first QoE metric may include at least one of an interaction metric, a perception metric, and an outcome metric. An interaction metric may quantify or qualify what happens during a user interaction with a product or service of a computing platform. By way of non-limiting example, interaction metrics may include first response time, page load speed, average handling time, and conversion rate. A perception metric may quantify or qualify what a user thinks or feels about what happened during a user interaction with a product or service of a computing platform. By way of non-limiting example, perception metrics may include a user effort score, a user satisfaction score, and a user experience index, which may be obtained by user survey or by user sentiment analysis. An outcome metric may quantify or qualify what a user does as a result of their interaction with a product or service of a computing platform. By way of non-limiting example, outcome metrics may include user churn rate, user retention rate, user lifetime cycle, average order value, cart abandon rate, and net promoter score.

In some embodiments, operation 402 may include receiving, from a second computing platform, a second QoE metric of a second application associated with the second computing platform. In further aspects of the embodiments, operation 402 may include assigning a first QoE weight to the first QoE metric and a second QoE weight to the second QoE metric. In further aspects of the embodiments, operation 402 may include generating a composite QoE metric based on the first QoE weight, the first QoE metric, the second QoE weight, and the second QoE metric.

In further aspects of the embodiments, operation 402 may include determining a platform infrastructure metric associated with the first computing platform. In further aspects of the embodiments, operation 402 may include determining a radio network metric associated with a client device hosting the first application. In further aspects of the embodiments, operation 402 may include assigning a first user experience (UX) weight to the composite QoE metric, a second UX weight to the platform infrastructure metric, and a third UX weight to the radio network metric. In further aspects of the embodiments, operation 402 may include generating a composite UX score based on the first UX weight, the composite QoE metric, the second UX weight, the platform infrastructure metric, the third UX weight, and the radio network metric. The platform infrastructure metric may include at least one of an availability metric, a bandwidth metric, a bitrate metric, a throughput metric, a jitter metric, a packet loss metric, and a latency metric.

Operation 404 may include providing a first QoE metric to an artificial intelligence (AI) model executing on a first computing platform. In some embodiments, providing a first QoE metric to an AI model may include providing a composite QoE metric to the AI model. In some embodiments, providing a first QoE metric to an AI model may include providing a composite UX score to the AI model.

Operation 406 may include determining, by an AI model and based on a first QoE metric, a recommended or an optimal configuration for a communications network associated with a first computing platform. In some embodiments, the recommended or the optimal configuration for the communications network may be directed toward reaching or improving the first QoE metric, wherein the first QoE metric may include an observed condition (e.g., an actual QoE metric) or a predicted condition (e.g., a target QoE metric). In some embodiments, the AI model may be trained based on UX data and network configuration data. In further aspects of the embodiments, the UX data may be associated with at least one computing platform, and the network configuration data may be associated with at least one communications network supporting the at least one computing platform. In further aspects of the embodiments, the AI model may be trained by mapping the UX data to the network configuration data.

Operation 408 may include providing a recommended or an optimal configuration to an operator of a communications network. In some embodiments, the operator of the communications network may be a computing platform executing an AI model for outputting a recommended or an optimal network configuration to improve or to achieve an input QoE metric. In some embodiments, the communications network may be a third-party communications network and the operator of the communications network may be a third-party network operator.

### Hardware Overview

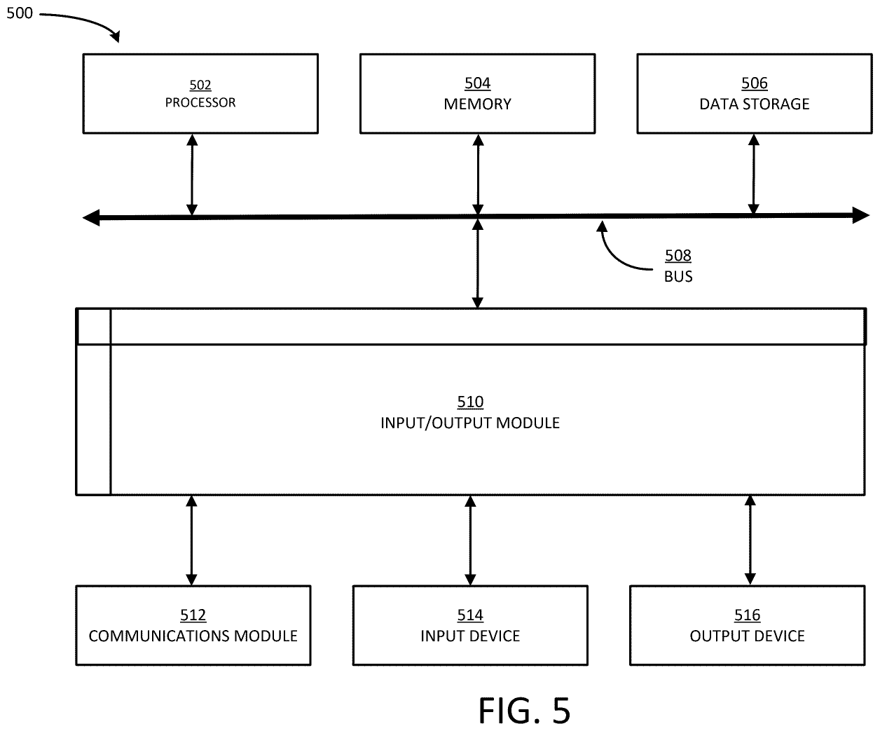

FIG. 5 is a block diagram illustrating an exemplary computer system 500 with which client devices, and the method in FIG. 4, may be implemented, according to some embodiments.

In certain aspects, the computer system 500 may be implemented using hardware or a combination of software and hardware, either in a dedicated server, or integrated into another entity, or distributed across multiple entities.

Computer system 500 (e.g., client device(s) 110 and server(s) 130) may include bus 508 or another communication mechanism for communicating information, and a processor 502 (e.g., processors 212) coupled with bus 508 for processing information. By way of example, computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 500 may include, in addition to hardware, code that creates an execution environment for the computer program in question, e.g., code that constitutes processor firmware, a protocol stack, a database management system, an operating system, or a combination of one or more of them stored in an included memory 504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. Processor 502 and the memory 504 may be supplemented by, or incorporated in, special purpose logic circuitry.

The instructions may be stored in memory 504 and implemented in one or more computer program products, e.g., one or more modules of computer program instructions encoded on a computer-readable medium for execution by, or to control the operation of, computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. Input/output module 510 may be any input/output module. Exemplary input/output modules 510 include data ports such as Universal Serial Bus (USB) ports. The input/output module 510 may be configured to connect to a communications module 512. Exemplary communications modules 512 (e.g., communications modules 218) include networking interface cards, such as Ethernet cards and modems. In certain aspects, input/output module 510 may be configured to connect to a plurality of devices, such as an input device 514 (e.g., input device 214) and/or an output device 516 (e.g., output device 216). Exemplary input devices 514 include a keyboard and a pointing device, e.g., a mouse or a trackball, by which a user may provide input to computer system 500. Other kinds of input devices 514 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 516 include display devices, such as an LCD (liquid crystal display) monitor, for displaying information to the user.

According to one aspect of the present disclosure, client device(s) 110 and server(s) 130 may be implemented using computer system 500 in response to processor 502 executing one or more sequences of one or more instructions contained in memory 504. Such instructions may be read into memory 504 from another machine-readable medium, such as data storage device 506. Execution of the sequences of instructions contained in memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 500 may include clients and servers. A client and server may be generally remote from each other and typically interact through a communication network. The relationship of client and server arises by virtue of computer programs running on the respective computers and having a client-server relationship to each other. Computer system 500 may be, for example, and without limitation, a desktop computer, laptop computer, or tablet computer. Computer system 500 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires forming bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method, comprising:
determining, by a first computing platform, a first quality of experience (QoE) metric of a first application associated with the first computing platform;
providing the first QoE metric to an artificial intelligence (AI) model executing on the first computing platform;
determining, by the AI model and based on the first QoE metric, a recommended configuration for a communications network associated with the first computing platform; and
providing the recommended configuration to an operator of the communications network.

2. The computer-implemented method of claim 1, wherein the first QoE metric includes at least one of an interaction metric, a perception metric, and an outcome metric.

3. The computer-implemented method of claim 1, further comprising:
receiving, from a second computing platform, a second QoE metric of a second application associated with the second computing platform;
assigning a first QoE weight to the first QoE metric and a second QoE weight to the second QoE metric; and
generating a composite QoE metric based on the first QoE weight, the first QoE metric, the second QoE weight, and the second QoE metric.

4. The computer-implemented method of claim 3, wherein providing the first QoE metric to the AI model includes providing the composite QoE metric to the AI model.

5. The computer-implemented method of claim 3, further comprising:
determining a platform infrastructure metric associated with the first computing platform;
determining a radio network metric associated with a client device hosting the first application;
assigning a first user experience (UX) weight to the composite QoE metric, a second UX weight to the platform infrastructure metric, and a third UX weight to the radio network metric; and
generating a composite UX score based on the first UX weight, the composite QoE metric, the second UX weight, the platform infrastructure metric, the third UX weight, and the radio network metric.

6. The computer-implemented method of claim 5, wherein the platform infrastructure metric includes at least one of an availability metric, a bandwidth metric, a bitrate metric, a throughput metric, a jitter metric, a packet loss metric, and a latency metric.

7. The computer-implemented method of claim 5, wherein providing the first QoE metric to the AI model includes providing the composite UX score to the AI model.

8. The computer-implemented method of claim 1, wherein the AI model is trained based on UX data and network configuration data.

9. The computer-implemented method of claim 8, wherein the UX data is associated with at least one computing platform, and wherein the network configuration data is associated with at least one communications network supporting the at least one computing platform.

10. The computer-implemented method of claim 8, wherein the AI model is trained by mapping the UX data to the network configuration data.

11. A system, comprising:
one or more processors; and
a memory storing instructions that, when executed by the one or more processors, cause the system to perform operations including:
determining, by a first computing platform, a first quality of experience (QoE) metric of a first application associated with the first computing platform;
providing the first QoE metric to an artificial intelligence (AI) model executing on the first computing platform;
determining, by the AI model and based on the first QoE metric, a recommended configuration for a communications network associated with the first computing platform; and
providing the recommended configuration to an operator of the communications network.

12. The system of claim 11, wherein the first QoE metric includes at least one of an interaction metric, a perception metric, and an outcome metric.

13. The system of claim 11, wherein the operations further include:
receiving, from a second computing platform, a second QoE metric of a second application associated with the second computing platform;
assigning a first QoE weight to the first QoE metric and a second QoE weight to the second QoE metric; and
generating a composite QoE metric based on the first QoE weight, the first QoE metric, the second QoE weight, and the second QoE metric.

14. The system of claim 13, wherein providing the first QoE metric to the AI model includes providing the composite QoE metric to the AI model.

15. The system of claim 13, wherein the operations further include:
determining a platform infrastructure metric associated with the first computing platform;
determining a radio network metric associated with a client device hosting the first application;
assigning a first user experience (UX) weight to the composite QoE metric, a second UX weight to the platform infrastructure metric, and a third UX weight to the radio network metric; and
generating a composite UX score based on the first UX weight, the composite QoE metric, the second UX weight, the platform infrastructure metric, the third UX weight, and the radio network metric.

16. The system of claim 15, wherein the platform infrastructure metric includes at least one of an availability metric, a bandwidth metric, a bitrate metric, a throughput metric, a jitter metric, a packet loss metric, and a latency metric.

17. The system of claim 15, wherein providing the first QoE metric to the AI model includes providing the composite UX score to the AI model.

18. The system of claim 11, wherein the AI model is trained based on UX data and network configuration data.

19. The system of claim 18, wherein:
the UX data is associated with at least one computing platform;
the network configuration data is associated with at least one communications network supporting the at least one computing platform; and
the AI model is trained by mapping the UX data to the network configuration data.

20. A non-transitory computer-readable storage medium storing instructions encoded thereon that, when executed by a processor, cause the processor to perform operations comprising:
determining, by a first computing platform, a first quality of experience (QoE) metric of a first application associated with the first computing platform;
receiving, from a second computing platform, a second QoE metric of a second application associated with the second computing platform;
assigning a first QoE weight to the first QoE metric and a second QoE weight to the second QoE metric;
generating a composite QoE metric based on the first QoE weight, the first QoE metric, the second QoE weight, and the second QoE metric;
providing the composite QoE metric to an artificial intelligence (AI) model executing on the first computing platform;
determining, by the AI model and based on the composite QoE metric, a recommended configuration for a communications network associated with the first computing platform; and
providing the recommended configuration to an operator of the communications network.
